(19) United States
(12) Patent Application Publication
(10) Pub. No.: US 2004/0017345 A1
(43) Pub. Date: Jan. 29, 2004

(54) Liquid crystal display and driving method thereof having precharging scheme

(76) Inventor: Seung-Woo Lee, Seoul (KR)

Correspondence Address: Michael A. Cantor, 55 Griffin South Road, Bloomfield, CT, 06002, US

(21) Appl. No.: 10/627,120

(22) Filed: Jul. 24, 2003

(30) Foreign Application Priority Data
Jul. 26, 2002 (KR) 2002-44155

(51) Int. Cl. G09G 3/36

(52) U.S. Cl. 345/87

(57) ABSTRACT

A liquid crystal display includes: a liquid crystal panel assembly including gate lines, data lines, and pixels connected to the gate lines and the data lines; a signal controller receiving image data, a vertical synchronization signal, a horizontal synchronization signal, and a data enable signal, generating control signals used for driving the panel assembly, counting the number of pulses of the horizontal synchronization from a pulse of the vertical synchronization signal to a subsequent pulse of the data enable signal pulse, and generating a vertical synchronization start signal having a main-charging pulse in synchronization with the subsequent pulse of the data enable signal pulse and a precharging pulse before the main-charging pulse; a gate driver for activating the pixels based on the precharging pulse and the main-charging pulse; and a data driver receiving the image data from the signal controller and writing the image data on the activated pixels.

### BACKGROUND OF THE INVENTION

(a) Field of the Invention

The present invention relates to a liquid crystal display and a driving method thereof, and more specifically to a liquid crystal display and a driving method thereof having a precharging scheme.

(b) Description of Related Art

As personal computers and television sets become lighter and thinner, display devices are also required to be lighter and thinner. For satisfying those needs, flat panel displays such as liquid crystal display (LCD) instead of cathode ray tube (CRT) are developed and utilized in various fields.

A panel of LCD includes a panel having a pixel pattern in matrix array and an opposite panel. A liquid crystal layer having dielectric anisotropy is interposed between two the panels. The LCD displays a desired image by controlling the transmittance of the light passing through the liquid crystal layer by controlling the intensity of electric field applied to the liquid crystal layer.

Recently, the number of scanning lines, i.e., gate lines increases as the resolution becomes higher; therefore the time to charge pixels in one row decreases rapidly. To compensate the reduced charging time, precharging is used. That is, the pixels to be charged are precharged with data voltages for adjacent pixels having the same polarity, and then they are charged with their own data voltages. That is, the gate lines are driven twice in one frame.

To apply a gate-on voltage twice in a frame to one gate line, a signal controller of an LCD generates a vertical synchronization start signal (STV) twice in each frame to be supplied for a gate driver. The STV is generated based on a data enable signal (DE). For example, the number of blank sections of the DE is counted by a counter and then the STV is generated in advance on a designated time based on the count.

However, since the DE becomes high only when valid data are present, this scheme has a problem when the valid data is irregularly introduced. That is, the irregular timing of the valid data makes the blank sections of the DE be irregular, which in turn makes it difficult to generate the vertical synchronization start signal STV on exact time.

### SUMMARY OF THE INVENTION

The motivation of the present invention is to solve the problems of the conventional art.

A liquid crystal display is provided, which includes: a liquid crystal panel assembly including a plurality of gate lines, a plurality of data lines, and a plurality of pixels connected to the gate lines and the data lines; a signal controller receiving image data, a vertical synchronization signal, a horizontal synchronization signal, and a data enable signal from an external device, generating control signals used for driving the liquid crystal panel assembly, counting the number of pulses of the horizontal synchronization signal from a pulse of the vertical synchronization signal to a subsequent pulse of the data enable signal, and generating a vertical synchronization start signal having a main-charging pulse in synchronization with the subsequent pulse of the data enable signal pulse and a precharging pulse before the main-charging pulse; a gate driver for activating the pixels based on the precharging pulse and the main-charging pulse; and a data driver receiving the image data from the signal controller and writing the image data on the activated pixels.

The precharging pulse is generated two clocks or four clocks ahead of the main-charging pulse in case of 1-dot inversion and 2-dot inversion, respectively.

A method of driving a liquid crystal display is provided, which includes: determining whether polarities of vertical and horizontal synchronization signals are positive or negative; setting count reference points for the vertical and the horizontal synchronization signals depending on the polarities of the synchronization signals; determining whether a back porch of the vertical synchronization signal in a predetermined number of frames is maintained constant; counting the number of the pulses of the horizontal synchronization signal from a pulse of the vertical synchronization signal if the back porch of the vertical synchronization signal is maintained constant; and generating a pulse of a vertical synchronization start signal if the counted number of the pulses of the horizontal synchronization signal reaches to a predetermined value.

The predetermined value may be equal to (X-2×R), where X is a count value when a pulse of the data enable signal is generated, and R is an inversion unit of dot inversion.

The polarity determination preferably includes: counting a high section when a pulse indicating a rising edge of the vertical or the horizontal synchronization signal is generated; counting a low section when a pulse indicating a falling edge of the vertical or the horizontal synchronization signal is generated; and determining that the vertical or the horizontal synchronization signal is negative type if the counted number of the high section is larger than the counted number of the low section by comparing the counted values of the high section and the low section and that the vertical or the horizontal synchronization signal is positive type if the counted number of the high section is smaller than the counted number of the low section by comparing the counted values of the high section and the low section.

Preferably, the counting reference points are falling edges of the vertical and the horizontal synchronization signals if the polarity of the vertical and the horizontal synchronization signals is positive type, and rising edges of the vertical and the horizontal synchronization signals if the polarity of the vertical and the horizontal synchronization signal is negative type.

### BRIEF DESCRIPTION OF THE DRAWINGS

The above and other advantages of the present invention will become more apparent by describing preferred embodiments thereof in detail with reference to the accompanying drawings in which:

FIG. 1 is a block diagram of an LCD according to an embodiment of the present invention;

FIG. 2 shows waveforms of signals for generating a vertical synchronization start signal using a memory according to an embodiment of the present invention;

FIG. 3 shows waveforms of signals for generating a vertical synchronization start signal according to another embodiment of the present invention;

FIG. 4 shows waveforms for illustrating an exemplary method of determining polarity of a synchronization signal;

FIG. 5 is a flowchart illustrating an exemplary process of determining the polarity of a synchronization signal shown in FIG. 4; and

FIG. 6 is a flowchart illustrating an exemplary process of generating a vertical synchronization start signal for an LCD according to an embodiment of the present invention.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present.

Then, liquid crystal displays and driving methods thereof according to embodiments of the present invention will be described with reference to the drawings.

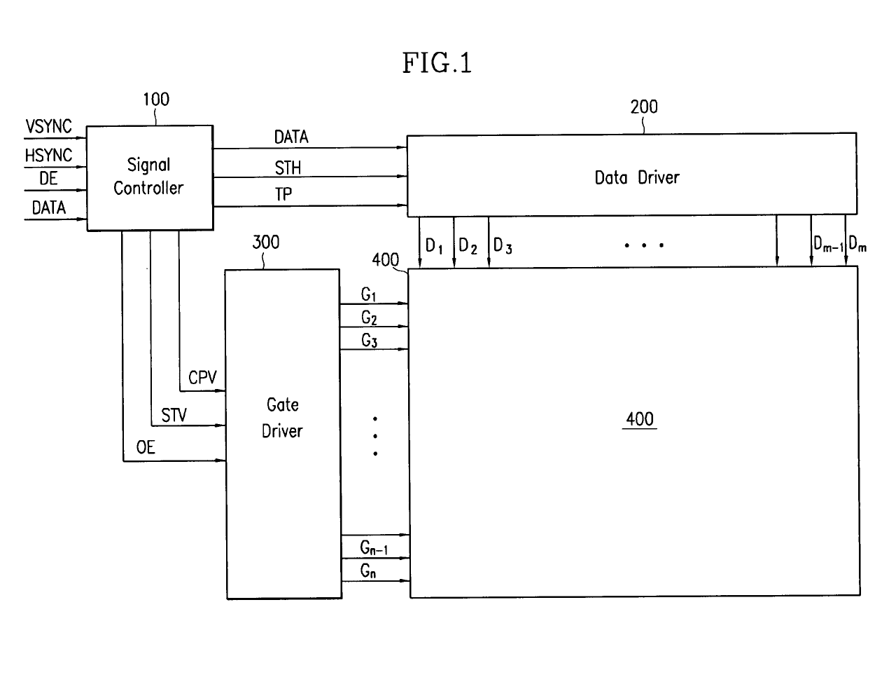

FIG. 1 is a block diagram of an LCD according to an embodiment of the present invention.

As shown in FIG. 1, an LCD according to an embodiment of the present invention includes a signal controller 100, a data driver 200, a gate driver 300, and a liquid crystal panel assembly 400.

The signal controller 100 receives a vertical synchronization signal VSYNC, a horizontal synchronization signal HSYNC, a data enable signal DE, and RGB image data DATA from external graphic source (not shown). The signal controller 100 converts the data format of the image data DATA to be suitable for the specification of the data driver 200, and generates a horizontal synchronization start signal STH for providing standard timing of signal transmission between the data driver 200 and the liquid crystal panel assembly 400, and load signal TP. The signal controller 100 outputs the converted image data, the horizontal synchronization start signal STH, and the load signal TP to the data driver 200.

In addition, the signal controller 100 generates a vertical synchronization start signal STV for selecting the first gate line, a gate clock CPV for sequentially selecting the next gate lines, and an output enable signal OE for controlling the output of the gate driver 300, which are provided for the gate driver 300.

Especially, the vertical synchronization start signal STV from the signal controller 100 includes a pulse for precharging as well as a pulse for main charging in each frame.

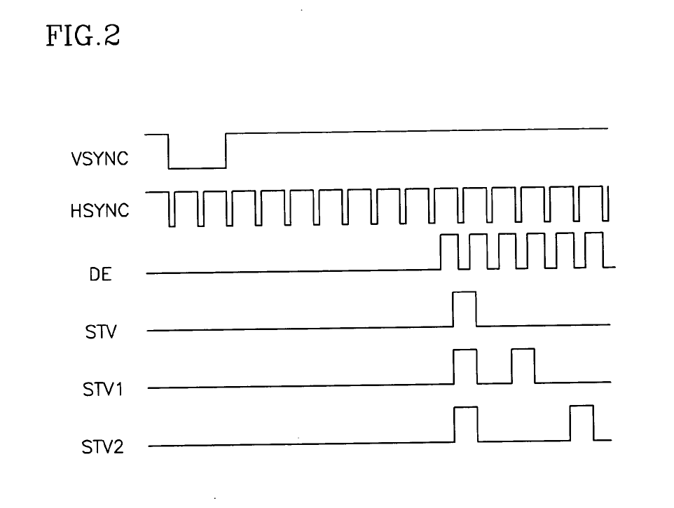

FIG. 2 shows waveforms of signals for generating vertical synchronization start signals using a memory according to an embodiment of the present invention.

In FIG. 2, the reference characters VSYNC, HSYNC, DE, STV1 and STV2 are waveforms of a vertical synchronization signal, a horizontal synchronization signal, a data enable signal, a vertical synchronization start signal, a vertical synchronization start signal for 1-dot inversion precharging, and a vertical synchronization start signal for 2-dot inversion precharging, respectively. The first pulses and the second pulses of “STV1” and “STV2” are for precharging and for main charging with their own image data, respectively. In the same manner, the first pulse of “STV2” is for precharging corresponding gate line and the second pulse is for providing image data to be displayed to the pixel of corresponding gate line.

According to this embodiment, even if the valid data sections of a data enable signal DE are irregular, a vertical synchronization start signal proper to the valid data sections of the data enable signal DE is generated using a line memory storing image data for a pixel row. Especially, the vertical synchronization start signal has two sequential pulses respectively for precharging and main charging.

Examples of LCDs with precharging in random DE mode having irregular valid data sections, using line memory are disclosed in Korean Patent Application Serial No. 2001-0007453 filed on Feb. 15, 2001, U.S. patent application Ser. No. 10/075,285 filed on Feb. 15, 2002, Japanese Patent Application Serial No. 2001-142852 filed on May 14, 2001, Chinese Patent Application Serial No. 02108301.0 filed on Feb. 15, 2002, and European Patent Application Serial No. 02002092.1 filed on Feb. 12, 2002) and these applications are incorporated herein by reference.

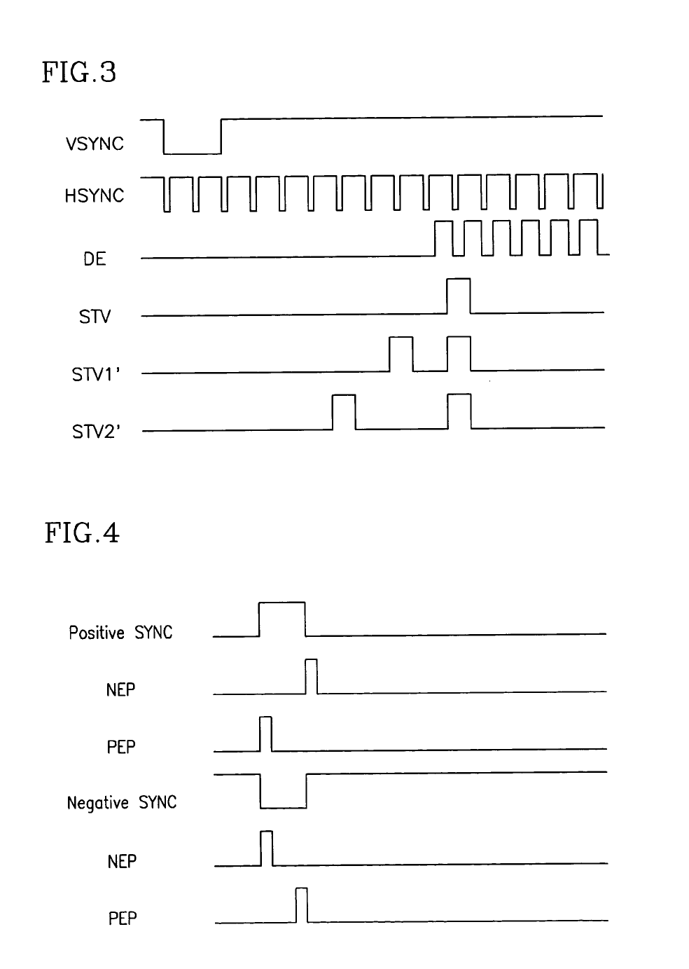

FIG. 3 shows waveforms of signals VSYNC, HSYNC, DE, STV, STV1′ and STV2′ used for an LCD according to another embodiment of the present invention.

The signal STV is a general vertical synchronization start signal, which is specially shown for comparison with vertical synchronization start signals STV1′ and STV2′ of this embodiment. The signal STV1′ is a vertical synchronization start signal for 1-dot inversion precharging and the signal STV2′ is a vertical synchronization start signal for 2-dot inversion precharging. The first pulse and the second pulses of each signal STV1′ or STV2′ is for precharging and for main charging.

The gate driver 300 generates gate signals responsive to the pulses of the vertical synchronization start signals STV1′ and STV2′. This embodiment is based on an observation that the number of the pulses of the horizontal synchronization signal HSYNC are constant between a pulse of the vertical synchronization signal VSYNC and a pulse of the data enable signal DE.

The signal controller 100 counts the number of the pulses of the horizontal synchronization signal HSYNC from a rising edge of the vertical synchronization signal VSYNC to the rising edge of the data enable signal DE. The signal controller 100 generates a main-charging pulse of the vertical synchronization start signal STV1′ or STV2′ right after the rising edge of the data enable signal DE using the counted number. Simultaneously, the signal controller 100 generates a precharging pulse of the vertical synchronization start signal STV1′ for 1-dot inversion at two clocks right before the rising edge of data enable signal DE, while it generate a precharging pulse of the vertical synchronization start signal STV2′ for 2-dot inversion at four clocks right before the rising edge of the data enable signal DE.

The generation of the vertical synchronization start signals STV1′ and STV2′ will be described later in more detail with reference to a flowchart.

The data driver 200 includes a plurality of data driver ICs, generates a plurality of data signals D1-Dm using the control signals STH and TP and the image data DATA supplied from the signal controller 100, and applies them to the liquid crystal panel assembly 400. For example, the data driver 200 latches the image data, which are inputted in a sequential manner, transforming the timing system from “dot at a time scanning” to “line at a time scanning,” and outputting the data signals D1, D2, . . . , Dm−1, and Dm to the data lines of the liquid crystal panel assembly 400.

The gate driver 300 includes a plurality of gate driver ICs, and scans the gate lines on the liquid crystal panel assembly 400 in response to the control signals CPV, STV, and OE from the signal controller 100. Here, “to scan” means to make the pixels connected to the gate lines be in writable state by applying a gate-on voltage to the gate lines in sequence.

In LCD according to this embodiment, a gate line is driven twice in one frame. That is, the gate-on voltage is repeatedly generated in response to both pulses of the vertical synchronization start signal STV1′ or STV2′, and applied to the gate lines. Therefore, each gate line is driven for precharge operation by the firstly-generated gate-on voltage, and driven again for main charging by the secondly-generated gate-on voltage.

The liquid crystal panel assembly 400 includes a plurality of gate lines, a plurality of data lines crossing the gate lines, and a plurality of pixels connected to the gate lines and the data lines and arranged in a matrix. Each pixel includes a liquid crystal (LC) capacitor (not shown), a thin film transistor (TFT) (not shown) having a gate, a source and a drain connected to one of the gate lines, one of the data lines, and the LC capacitor, respectively, and a storage capacitor (not shown) connected in parallel to the LC capacitor.

When the gate driver 300 applies a gate-on voltage in a pulse form to a gate line to turn on the TFTs of the pixels connected to the gate line, the data driver 200 applies data voltages to the data lines by the data driver 200. These voltages are applied to the LC capacitors and the storage capacitors through the TFTs of the pixels, and a prescribed display operation is performed by driving those capacitors.

The signal controller 100 generates the vertical synchronizations STV1′ and STV2′ using the relationship between vertical and horizontal synchronization signals VSYNC and HSYNC and a data enable signal DE as described above. Here, the time period between a rising edge of the vertical synchronization signal VSYNC (if the vertical synchronization signal is positive type) and a rising edge of a subsequent pulse of the data enable signal DE is called back porch. The back porch is always constant except for a moment when the format of the image signals is changing or the scaling is being modified for matching the image signal with the resolution of the LCD. Therefore, the signal controller 100 counts the number of the pulses of the horizontal synchronization signals HSYNC in a back porch and determines the timing for generating pulses of the vertical synchronization start signal STV1′ or STV2′. To count the number of the pulses of the horizontal synchronization signals HSYNC in the back porch, the polarities of the synchronization signals VSYNC and HSYNC are required to be determined.

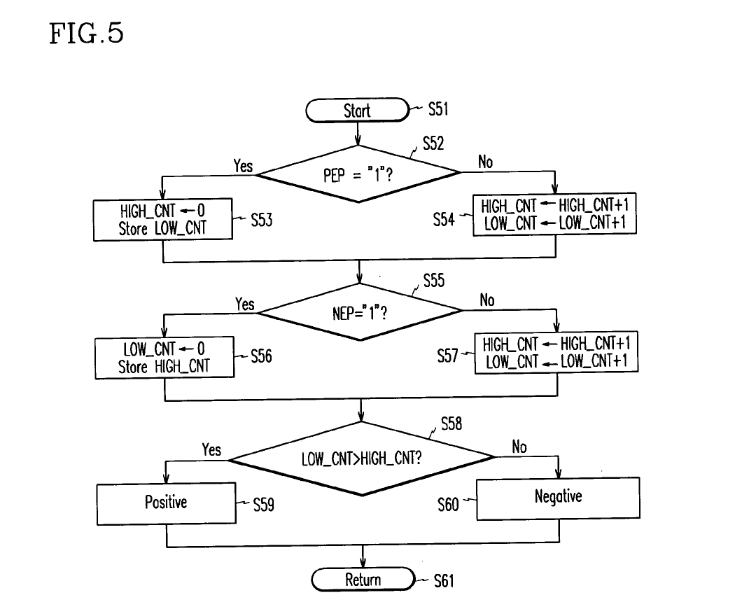

FIG. 4 shows waveforms of signals for illustrating a method of determining polarity of a synchronization signal SYNC, and FIG. 5 is a flowchart illustrating an exemplary method of determining polarity of a synchronization signal.

As shown in FIG. 4, edge pulses are generated at a rising edge and a falling edge of a synchronization signal SYNC which may be negative or positive type. A high synchronization signal SYNC has a high section shorter than a low section, while a low synchronization signal SYNC has a high section longer than a low section. Now, an edge pulse generated at a rising edge of the synchronization signal SYNC is named as a positive edge pulse PEP, while an edge pulse generated at a falling edge of the synchronization signal SYNC is defined as a negative edge pulse NEP.

Next, an exemplary method of determining the polarity of a synchronization signal is described with reference to FIG. 5.

First, the type of a synchronization signal SYNC is determined.

When a positive edge pulse PEP is generated, a high section is counted, while the low section is counted when a negative edge pulse NEP is generated. Then, the count values of the high and the low sections are compared and the type of the synchronization signal SYNC is determined to be negative if the count value of the high section is larger than that of the low section and to be positive type if the count value of the low section is larger than the high section.

The flowchart shown in FIG. 5 illustrates the determining procedure in detail.

First, when the operation starts (S51), it is determined whether the positive edge pulse PEP is “1” (high level) (S52). According to an embodiment of the present invention, a variable for counting the high section (hereinafter “high count variable”) HIGH_CNT, and a variable for counting the low section (hereinafter “low count variable”) LOW_CNT are introduced.

The high count variable HIGH_CNT is reset to zero for counting the high section if the positive edge pulse PEP is “1” in the step S52, and the counted value of the low count variable LOW_CNT then is stored (S53). On the other hand, if the positive edge pulse PEP is not “1” in the step S52, the values of both the high count variable HIGH_CNT and the low count variable LOW_CNT are increased by one.

Next, it is determined whether the negative edge pulse NEP is “1” (high level) (S55). The low count variable LOW_CNT is reset to zero for counting the low section if the negative edge pulse NEP is “1” in the step S55, and the counted value of the high count variable HIGH_CNT then is stored (S56). On the other hand, if the negative edge pulse NEP is not “1” in the step S55, the values of both the high count variable HIGH_CNT and the low count variable LOW_CNT are increased by one.

Next, the values of the high count variable HIGH_CNT and the low count variable LOW_CNT stored in the respective steps of S53 and S56 are compared (S58). If the value of the low count variable LOW_CNT is larger than that of the high count variable HIGH_CNT, then it is determined that the synchronization signal SYNC is positive type (S59). On the other hand, if the value of the high count variable HIGH_CNT is larger than the low count variable LOW_CNT, then it is determined that the synchronization signal SYNC is negative type (S60).

Next, the control flow is returned (S61) to repeat the above procedure.

The above-described method of determining the polarity of the synchronization signal SYNC is used to generate a vertical synchronization start signal in the signal controller 100.

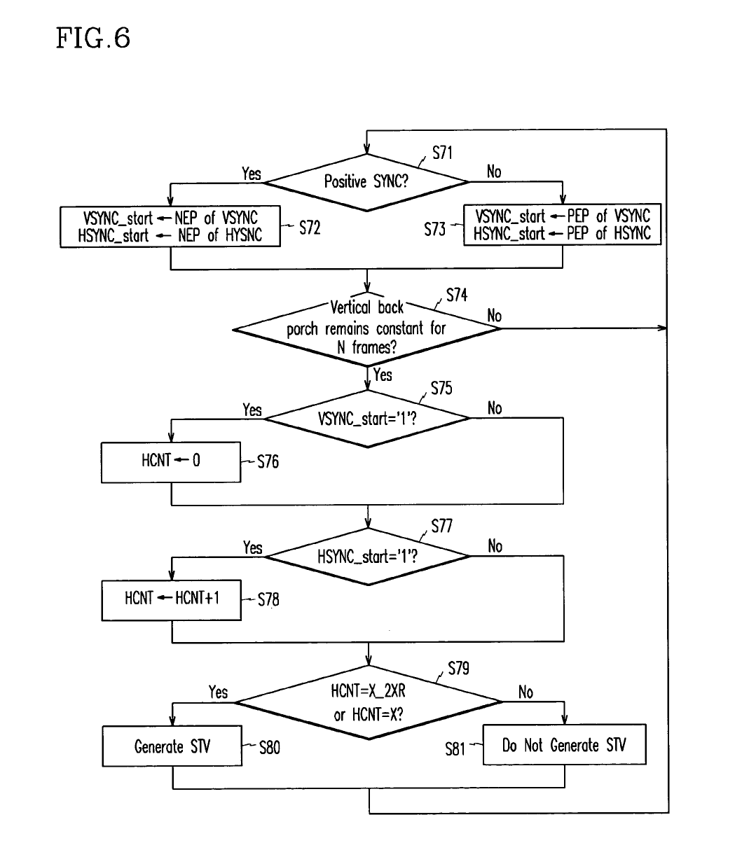

Now, a method of generating a vertical synchronization start signal according to an embodiment of the present invention is described with reference to FIG. 6.

FIG. 6 is a flowchart illustrating an exemplary process of generating a vertical synchronization start signal for an LCD according to an embodiment of the present invention.

If a control flow starts, it is determined whether the polarity of synchronization signals is positive type (S71) preferably using the above-described procedure shown FIG. 5. Some variables such as a vertical synchronization signal count reference variable VSYNC_start, a horizontal synchronization signal count reference variable HSYNC_start, and a horizontal synchronization signal count variable HCNT. As described above, since edge pulses are generated at both a rising edge and a falling edge of synchronization signal, one of the edge pulses is determined as a reference for counting depending on the polarity of the synchronization signals.

If the polarity of the synchronization signals is positive type, the count reference variables VSYNC_start and HSYNC_start are set to negative edge pulses NEPs for a vertical synchronization signal VSYNC and a horizontal synchronization signal HSYNC, respectively (S72). That is, if the polarity of the synchronization signals is positive type, count operation starts at the falling edge of each synchronization signal VSYNC or HSYNC.

On the contrary, if the polarity of the synchronization signals is not positive type, i.e., negative type, the count reference variables VSYNC_start and HSYNC_start are set to positive edge pulse PEPs of the vertical synchronization signal VSYNC and the horizontal synchronization signal HSYNC, respectively (S73). In other words, if the polarity of the synchronization signals is negative, count operation is performed at the rising edge of each synchronization signal VSYNC or HSYNC.

Next, it is determined whether a vertical back porch is maintained constantly for any N frames (S74). The vertical back porch is defined as a back porch of the vertical synchronization signal VSYNC, which is a time period from the rising of a pulse of the vertical synchronization signal to a subsequent pulse of a data enable signal DE. As described above, the back porch is always constant except for the moment when the format of image data is changing or the scaling is being modified for matching the image data with the resolution of the LCD. The step S74 confirms whether the vertical back porch is changed, and the control flow is returned to the root for determining the type of the synchronization signals if the vertical back porch is not constant.

If the vertical back porch is remained constant for any N frames, it is determined whether the vertical synchronization signal count reference variable VSYNC_start is “1” (S75). The step S75 is to confirm whether a pulse is generated in the vertical synchronization signal VSYNC. If the count reference variable VSYNC_start is “1,” the count variable HCNT is reset (S76), and if not, the flow is jumped to the next step S77. Therefore, the count variable HCNT starts counting whenever a pulse of the vertical synchronization signal VSYNC is generated.

Next, it is determined whether the horizontal synchronization signal count reference variable HSYNC_start is “1” (S77). The step S77 is to confirm whether a pulse is generated in the horizontal synchronization signal HSYNC. If the count reference variable HSYNC_start is “1,” the count variable HCNT is increased by one (up-counted) (S78), and if not, the flow is jumped to the next step S79. As a result, the count variable HCNT counts up the number of the pulses of the horizontal synchronization signal HSYNC by one in the vertical back porch.

As described above, since the number of the pulses of the horizontal synchronization signal HSYNC from a pulse of the vertical synchronization signal VSYNC to a subsequent pulse of the data enable signal DE is constant, a pulse of the data enable signal is generated when the count variable HCNT reaches to a predetermined value X. That is, the count value X indicates the time when a pulse of the data enable signal DE is generated. Therefore, a main charging pulse of a vertical synchronization start signal STV may be generated when the count variable HCNT reaches the count value X. In addition, a precharging pulse of the vertical synchronization start signal STV may be generated two clocks before that time point.

The steps S79 through S81 shown in FIG. 6 are to describe the above process. That is, it is determined whether the count variable HCNT reaches one of predetermined values X and (X-2×R) (S79). When the count variable HCNT reaches one of predetermined values X and (X-2×R), a pulse of a vertical synchronization start signal STV is generated, and if not, a pulse of the vertical synchronization start signal STV is not generated (S81). Here, R is a constant indicating the types of dot inversion, which is equal to one for 1-dot inversion and two for 2-dot inversion.

If the step S80 or S81 is completed, the control flow is returned to the root for determining the type of the synchronization signals. Therefore, the generated vertical synchronization start signal STV has a precharging pulse before generation of a pulse of the data enable signal DE and a main charging pulse on generation of a pulse of the data enable signal DE.

As described above, an LCD and a driving method thereof according to an embodiment of the present invention can generate a vertical synchronization start signal including both pulses for precharging and main charging of pixels by counting the number of the pulses of a horizontal synchronization signal in a vertical back porch without using memory.

This embodiment has various advantages compared with an embodiment using a memory. For example, a signal controller of an LCD with a precharging scheme needs three line memories for 1-dot inversion and five line memories for 2-dot inversion. However, even only three line memories are a big burden to the signal controller of the LCD. First, the cost of an IC including the signal controller increases because the space occupied by the memories increases. In addition, control logic and data bus routing in the signal controller becomes complicated due to the memory. Such problems become more serious in 2-dot inverse precharging. This embodiment solves the problems by implementing precharging for the irregular valid data section without using memory.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a liquid crystal panel assembly including a plurality of gate lines, a plurality of data lines, and a plurality of pixels connected to the gate lines and the data lines;
a signal controller receiving image data, a vertical synchronization signal, a horizontal synchronization signal, and a data enable signal from an external device, generating control signals used for driving the liquid crystal panel assembly, counting the number of pulses of the horizontal synchronization signal from a pulse of the vertical synchronization signal to a subsequent pulse of the data enable signal, and generating a vertical synchronization start signal having a main-charging pulse in synchronization with the subsequent pulse of the data enable signal pulse and a precharging pulse before the main-charging pulse;
a gate driver for activating the pixels based on the precharging pulse and the main-charging pulse; and
a data driver receiving the image data from the signal controller and writing the image data on the activated pixels.

2. The liquid crystal display of claim 1, wherein the precharging pulse is generated two clocks ahead of the main-charging pulse in case of 1-dot inversion.

3. The liquid crystal display of claim 1, wherein the precharging pulse is generated four clocks ahead of the main-charging pulse in case of 2-dot inversion.

4. A method of driving a liquid crystal display, the method comprising:
determining whether polarities of vertical and horizontal synchronization signals are positive or negative;
setting count reference points for the vertical and the horizontal synchronization signals depending on the polarities of the synchronization signals;
determining whether a back porch of the vertical synchronization signal in a predetermined number of frames is maintained constant;
counting the number of the pulses of the horizontal synchronization signal from a pulse of the vertical synchronization signal if the back porch of the vertical synchronization signal is maintained constant; and
generating a pulse of a vertical synchronization start signal if the counted number of the pulses of the horizontal synchronization signal reaches to a predetermined value.

5. The method of claim 4, wherein the predetermined value is equal to (X-2×R), where X is a count value when a pulse of the data enable signal is generated, and R is an inversion unit of dot inversion.

6. The driving method of claim 4, wherein the polarity determination comprises:
counting a high section when a pulse indicating a rising edge of the vertical or the horizontal synchronization signal is generated;
counting a low section when a pulse indicating a falling edge of the vertical or the horizontal synchronization signal is generated; and
determining that the vertical or the horizontal synchronization signal is negative type if the counted number of the high section is larger than the counted number of the low section by comparing the counted values of the high section and the low section and that the vertical or the horizontal synchronization signal is positive type if the counted number of the high section is smaller than the counted number of the low section by comparing the counted values of the high section and the low section.

7. The driving method of claim 4, wherein the counting reference points are falling edges of the vertical and the horizontal synchronization signals if the polarity of the vertical and the horizontal synchronization signals is positive type, and rising edges of the vertical and the horizontal synchronization signals if the polarity of the vertical and the horizontal synchronization signal is negative type.
